(19) United States
(12) Patent Application Publication
(10) Pub. No.: US 2012/0287158 A1
(43) Pub. Date: Nov. 15, 2012

(54) DISPLAY APPARATUS, CONTROL METHOD FOR DISPLAY APPARATUS, AND STORAGE MEDIUM

(75) Inventor: Takumi Miyakawa, Yokohama-shi (JP)

(73) Assignee: CANON KABUSHIKI KAISHA, Tokyo (JP)

(21) Appl. No.: 13/454,506

(22) Filed: Apr. 24, 2012

(30) Foreign Application Priority Data
May 10, 2011 (JP) 2011-105413

(51) Int. Cl. G09G 5/00

(52) U.S. Cl. 345/633

(57) ABSTRACT

To display a captured image, a display apparatus includes an acquisition unit, a display unit, and a setting unit. The acquisition unit acquires, from an external apparatus, additional information that is to be displayed in association with an object in the captured image. The display unit displays the additional information acquired by the acquisition unit in association with the object. The setting unit allows a user to set a set number of objects in association with which the additional information is to be displayed by the display unit. The acquisition unit acquires, from the external apparatus, the additional information according to the set number of objects.

### BACKGROUND OF THE INVENTION

1. Field of the Invention

The present invention relates to a display apparatus configured to combine information with a captured image to display a combined image.

2. Description of the Related Art

In recent years, there has been an augmented reality (AR) technique which combines additional information of an object in a captured image photographed by a camera with the captured image to display a combined image. For example, Sekai Camera produced by Tonchidot Corporation combines additional information of an object in a captured image photographed by a camera with the captured image to display a combined image, based on position information obtained by using the Global Positioning System (GPS).

Further, U.S. Patent Application Publication No. 2002-0047905 discusses a technique which specifies an object in a captured image based on feature information of the object acquired from a portable terminal carried by the object, acquires additional information about the specified object, and displays the additional information at a position near the object in the captured image.

However, when there is a lot of objects in a captured image, it may be difficult to see additional information if additional information of each of all the objects is displayed. Further, if additional information is acquired from an external apparatus, acquiring additional information of each of all the objects may increase a communication load.

### SUMMARY OF THE INVENTION

The present invention is directed to a display apparatus capable of making additional information easily seen and reducing a communication load when displaying the additional information in association with an object in a captured image.

According to an aspect of the present invention, a display apparatus configured to display a captured image includes an acquisition unit configured to acquire, from an external apparatus, additional information that is to be displayed in association with an object in the captured image, a display unit configured to display the additional information acquired by the acquisition unit in association with the object, and a setting unit configured to allow a user to set a set number of objects in association with which the additional information is to be displayed by the display unit, wherein the acquisition unit is configured to acquire, from the external apparatus, the additional information according to the set number of objects.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a system according to an exemplary embodiment.

FIG. 2 illustrates an example of a database stored in a server.

FIG. 3 illustrates a hardware configuration of a viewer.

FIG. 4 is a block diagram illustrating software functions of the viewer.

FIG. 5 illustrates a display screen to be used when a user sets an upper limit number.

FIG. 6 is a flowchart of processing executed by the viewer.

### DESCRIPTION OF THE EMBODIMENTS

Various exemplary embodiments, features, and aspects of the invention will be described in detail below with reference to the drawings.

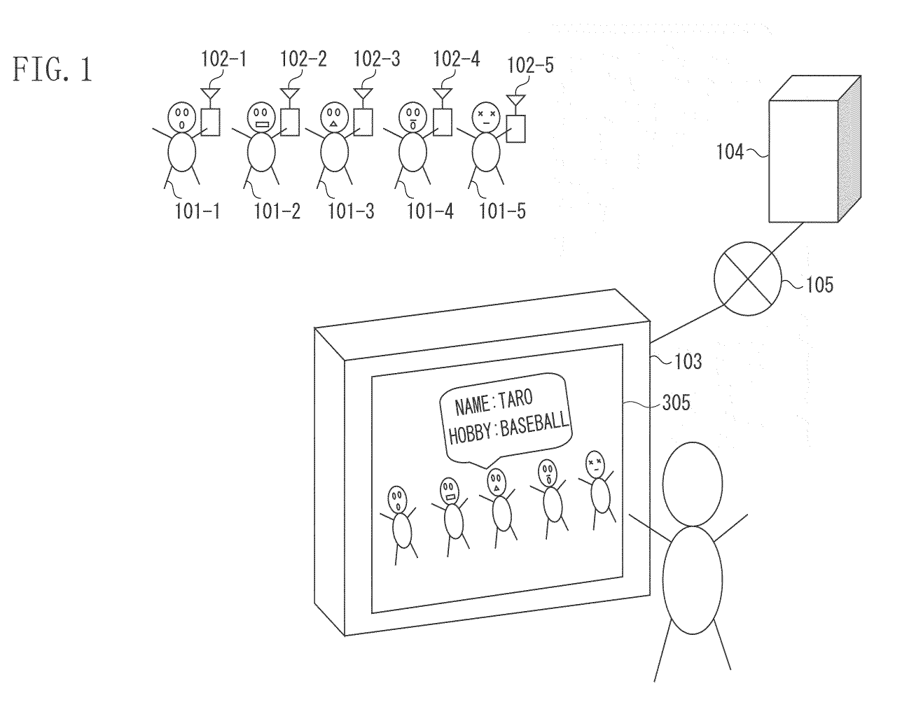

FIG. 1 illustrates a configuration of a system according to an exemplary embodiment.

Objects 101-1 to 101-5 respectively have wireless tags 102-1 to 102-5. The wireless tags 102-1 to 102-5 are communication apparatuses capable of communicating in ad hoc mode in a wireless local area network (LAN) based on Institute of Electrical and Electronics Engineers (IEEE) 802.11 series, which directly communicate between the communication apparatuses. The wireless tags 102-1 to 102-5 periodically transmit identification information. The identification information is information uniquely indicating an owner (an object) of the wireless tag and is peculiarly set to each wireless tag. In addition, the identification information is transmitted while being contained in an information element (IE) of a beacon based on IEEE 802.11 series.

A viewer 103 is an information processing apparatus including a photographing function (in the present exemplary embodiment, a display apparatus). A display unit 305 in the viewer 103 combines, with a captured image, additional information of an object, for example, a name and a hobby of the object, in the form of a balloon at a position near the object in the captured image to display a combined image. A server 104 is connected to the viewer 103 via a network 105. The server 104 transmits additional information and feature information corresponding to the identification information of the wireless tag to the viewer 103 in response to an inquiry from the viewer 103. The feature information indicates a feature of a face of an owner of the wireless tag and is used for detecting the owner of the wireless tag by image processing.

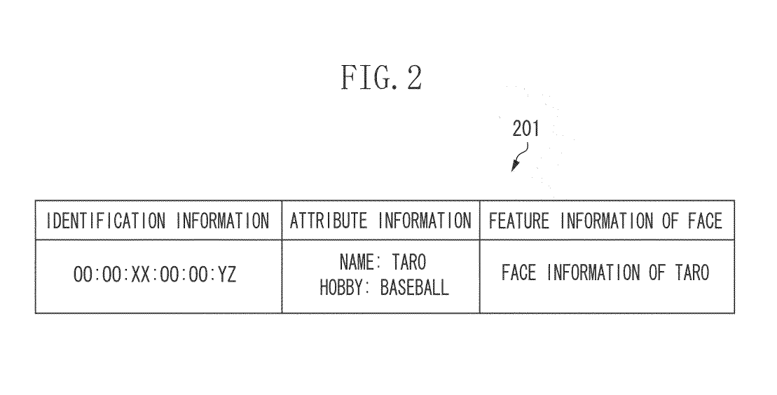

FIG. 2 illustrates an example of a database 201 stored in the server 104. In the database 201, the additional information and feature information of the owner are managed in association with the identification information uniquely indicating the owner of the wireless tag. The additional information is information of, for example, a name and a hobby of the owner of the wireless tag. In addition, the additional information may include information of a uniform resource locator (URL) of a blog of the owner. Further, the additional information and the feature information of the face are previously registered in the server 104 in association with the wireless tag for each object.

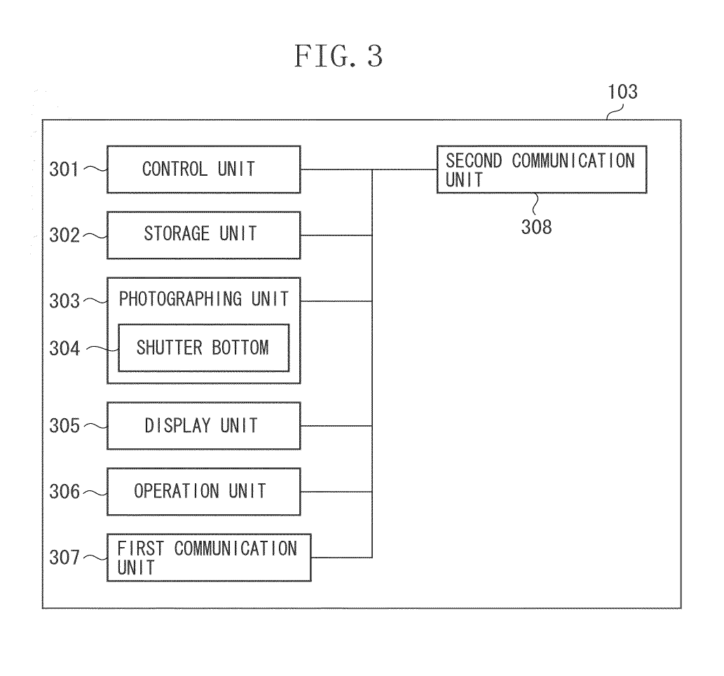

FIG. 3 illustrates a hardware configuration of the viewer 103.

A control unit 301 includes a computer such as a central processing unit (CPU) or a micro processing unit (MPU) and controls the entirety of the viewer 103 by executing programs stored in a storage unit 302. The storage unit 302 includes a read only memory (ROM) and a random access memory (RAM) and stores the programs to be executed by the control unit 301 and various information such as communication parameters. Various operations described below are performed by the control unit 301 executing programs stored in the storage unit 302. The storage unit 302 can be any one of storage media, such as a flexible disk, a hard disk, an optical disk, a magnet optical disk, a compact disc read only memory (CD-ROM), a compact disc recordable (CD-R), a magnetic tape, a nonvolatile memory card, or a digital versatile disc (DVD).

A photographing unit 303 includes a shutter button 304 and is configured to capture an image in response to pressing of the shutter button 304 by a user. A display unit 305 displays an image (captured image) photographed by the photographing unit 303 and also displays a combined image in which additional information is combined with the captured image. An operation unit 306 is configured to receive various operations from a user.

A first communication unit 307 includes an antenna not illustrated, and performs communications based on the IEEE 802.11 series with the wireless tags 102-1 to 102-5. A second communication unit 308 includes an antenna not illustrated and communicates with the server 104 via the network 105.

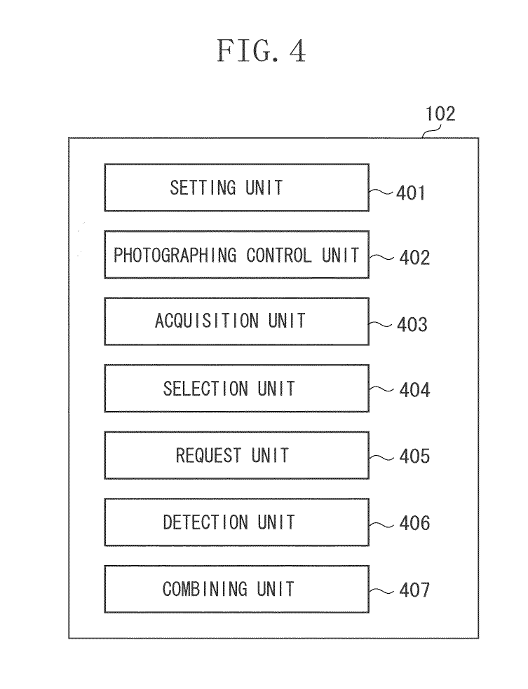

FIG. 4 illustrates software function blocks realized by the control unit 301 in the viewer 103 reading programs stored in the storage unit 302. In addition, at least a part of the software function blocks illustrated in FIG. 4 can be realized by hardware.

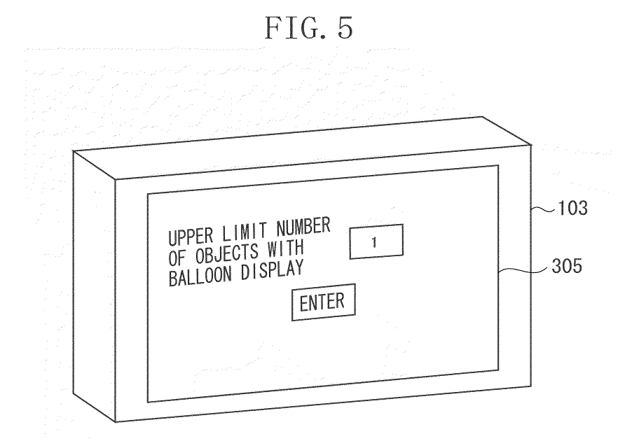

A setting unit 401 performs a display as illustrated in FIG. 5 on the display unit 305 and allows a user to set, via the operation unit 306, an upper limit number of objects additional information of which is to be displayed in the form of a balloon. A photographing control unit 402 performs photographing using the photographing unit 303 in response to pressing of the shutter button 304 by a user. An acquisition unit 403 acquires identification information from a wireless tags via the first communication unit 307. A selection unit 404 selects identification information of wireless tags whose number corresponds to the upper limit number of objects, according to the priority in the identification information of a plurality of wireless tags acquired by the acquisition unit 403.

A request unit 405 requests, to the server 104, additional information corresponding to identification information of the wireless tag selected by the selection unit 404 via the second communication unit 308. Further, the request unit 405 receives additional information corresponding to the identification information of the wireless tag selected by the selection unit 404 from the server 104, which has responded to the request, via the second communication unit 308. The received additional information contains additional information of an owner of the selected wireless tag and feature information of the face of the owner.

A detection unit 406 detects an object, which is an owner of the wireless tag, in a captured image photographed by the photographing unit 303 by image recognition processing, based on the feature information of the face acquired by the request unit 405. A combining unit 407 combines additional information of the object in the form of a balloon with the captured image photographed by the photographing unit 303 at a position near the object detected in the captured image, thus displaying a combined image on the display unit 305.

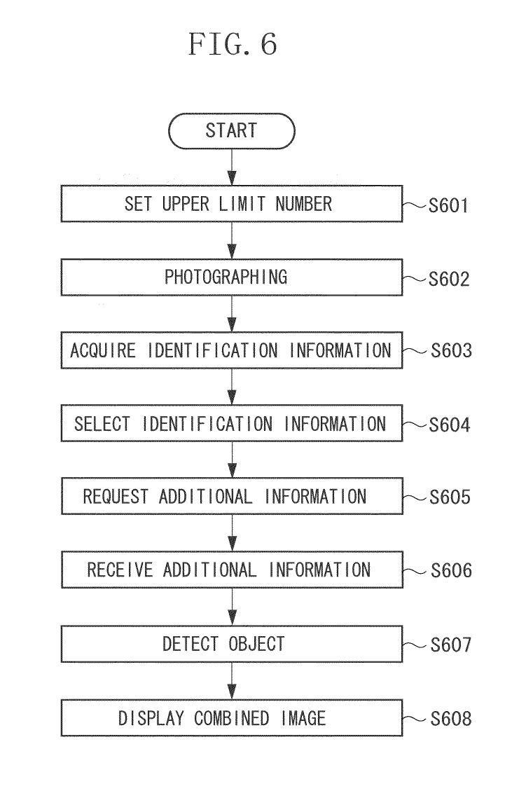

FIG. 6 is a flowchart of processing executed by the control unit 301 reading programs stored in the storage unit 302, when the display unit 305 in the viewer 103 displays a combined image.

In step S601, the setting unit 401 performs a display illustrated in FIG. 5 on the display unit 305 and allows a user to set an upper limit number of objects additional information of which is to be displayed in the form of a balloon via the operation unit 306. In the present exemplary embodiment, the user sets “1” as the upper limit number. Then, in step S602, when the user presses the shutter button 304, the photographing control unit 402 performs photographing. In the present exemplary embodiment, the user is assumed to perform photographing containing the objects 101-1 to 101-5.

In step S603, the acquisition unit 403 acquires identification information from wireless tags existing in a communication area of the first communication unit 307. In the present exemplary embodiment, the acquisition unit 403 is assumed to acquire identification information from each of five wireless tags 102-1 to 102-5.

In step S604, the selection unit 404 selects identification information of wireless tags in the number corresponding to the upper limit number of objects, according to the priority from among the identification information of a plurality of wireless tags acquired by the acquisition unit 403. In this instance, since the upper limit number is “1”, the selection unit 404 selects identification information of one wireless tag from among the identification information of five wireless tags. Further, as for the priority, the selection unit 404 uses a radio signal strength indication (RSSI) from the wireless tags. More specifically, the selection unit 404 sequentially gives higher priority to the identification information of the wireless tag with a higher radio signal strength indication. In this case, the radio signal strength indication from the wireless tag 102-3 is the highest, so that the identification information of the wireless tag 102-3 is selected.

In step S605, the request unit 405 requests, to the server 104, via the second communication unit 308, the additional information corresponding to the identification information of the wireless tag selected by the selection unit 404. In this case, the request unit 405 requests, to the server 104, the additional information corresponding to the identification information of the wireless tag 102-3 by transmitting the identification information of the wireless tag 102-3 to the server 104. Then, in step S606, the request unit 405 receives the additional information corresponding to the identification information of the wireless tag selected by the selection unit 404, from the server 104. In this case, the request unit 405 receives information of a name and a hobby of the object 101-3 and feature information of the face of the object 101-3, as the additional information corresponding to the identification information of the wireless tag 102-3.

In addition, when there is a lot of pieces of additional information corresponding to the identification information requested to the server 104, the server 104 automatically transmits a part of the corresponded additional information to the viewer 103. At this time, the server 104 notifies the viewer 103 that there is subsequent information. The viewer 103, having received this notification, notifies the user of that notification via the display unit 305. In such a case, the user can request the subsequent additional information via the operation unit 306. When this request is made by the user, the viewer 103 requests, to server 104, the subsequent additional information and then receives it.

In step S607, the detection unit 406 detects, by image recognition, the owner of a wireless tag in the captured image photographed by the photographing unit 303 based on the feature information of the face acquired by the acquisition unit 405. In this case, the detection unit 406 detects the object 101-3, who is the owner of the wireless tag 102-3, based on the feature information of the face of the object 101-3.

In step S608, a combining unit 407 displays a combined image on the display unit 305. In the combined image, the additional information of the objects is combined in the form of a balloon with the captured image photographed by the photographing unit 303 at a position near the object detected in the captured image. In the present exemplary embodiment, as illustrated in FIG. 1, the combining unit 407 combines the name and the hobby of the object 101-3 in the form of a balloon with the captured image at a position above the object 101-3, thus displaying a combined image on the display unit 305. If the detection unit 406 cannot detect an object corresponding to the owner of the wireless tag in step S607, the combining unit 407 does not display additional information in step S608. In this case, the combining unit 407 displays an error display indicating, for example, “there is no owner of the wireless tag”. With such display, the user can know that there is no owner of the wireless tag near the viewer 103.

In this way, even when a user photographs a plurality of objects, the display apparatus can selectively acquire additional information about objects located near the viewer 103 and display it. Further, since the additional information is combined in the form of a balloon with a captured image at a position near the object and displayed as apart of a combined image, the user can easily know whose additional information the displayed additional information is.

In addition, the above-described exemplary embodiment can be applied to either a still image or a moving image. In the case of a moving image, the exemplary embodiment can be realized by sequentially processing each frame of the moving image as a still image.

Further, as for a communication system between the wireless tag 102 and the viewer 103, Bluetooth, infrared data association (IrDA), or wireless universal serial bus (wireless USB) can be used, not limited to a wireless LAN. Further, different communication systems can be used for each wireless tag.

In addition, in the above-described exemplary embodiment, the higher priority is sequentially given to the higher radio signal strength indication (RSSI). However, the priority can be determined according to a frequency channel used by the wireless tag, not limited to the RSSI. For example, a case in which the channel “1” is used by a user registering hobbies about cooking as additional information and the channel “2” is used by a user registering hobbies about sports as additional information can be considered. In such a case, the user can set the priority to be higher according to the user's own hobby, for example, the wireless tag communicated by the channel 2. Accordingly, among a plurality of objects, the user can selectively acquire additional information of objects in which an information type (genre), which the user desires to obtain, is registered as additional information, to display a combined image.

Further, when the priority is determined according to the frequency channel used by the wireless tag, the display apparatus can sequentially perform scanning from the frequency channel with higher priority to acquire the identification information. When the number of pieces of the acquired identification information reaches the upper limit number of objects, the display apparatus can stop the scanning. More specifically, when the channel 2 has higher priority than the channel 1 and the display apparatus acquires identification information of one wireless tag, which corresponds to the upper limit number, by scanning in the channel 2, the display apparatus does not scan the channel 1. With this configuration, the amount of communication with wireless tags can be reduced as compared with the case of scanning all of the frequency channels, so that power saving and reducing processing load can be attained.

Further, the priority can be determined based on vender identification (vender ID) or a communication system of the wireless tag, other than the frequency channel.

Further, a captured image photographed by a photographing apparatus different from the viewer 103 can be transmitted from the photographing apparatus to the viewer 103. The viewer 103 can combine additional information of objects with the received captured image to display a combined image.

Further, the above-described type of wireless tag can be attached to the viewer 103. With this configuration, persons each having the viewer 103 can see additional information registered for each of them.

Further, in the above-described exemplary embodiment, the display apparatus combines additional information in the form of a balloon with a captured image to display a combined image. However, the display apparatus can present additional information by voice to a user. In this case, for announcing additional information about any object, the display apparatus presents, to a user, this information by surrounding the object with a square or a triangle in the captured image. With this configuration, the user can know the additional information about the object without reading characters.

Further, in the above-described exemplary embodiment, the display apparatus requests additional information and feature information of objects to the server 104. However, the display apparatus can request only one of additional information and feature information of objects or a part of them to the server 104, and other information can be stored in the viewer 103 beforehand. Further, the viewer 103 can store an entirety or a part of the additional information and the feature information which are received from the server 104, and the display apparatus does not request again the stored information to the server 104. With this configuration, a communication cost between the viewer 103 and the server 104 can be reduced, and power saving and reducing a processing load can be attained.

Further, the object is not limited to a person, and can be a building, for example, a store, or any object, for example, a statue. By notifying additional information of the building or the object to a user similarly to the above-described exemplary embodiment, the user can know the information of the building or the object. For example, a wireless tag can be attached to a signboard of a store or a sign part of a statue and the feature information of the signboard or the sign part is stored in a server 104 in association with the wireless tag. Further, the additional information of the store or the object is stored in the server 104. Then, when a user photographs the signboard or the sign part by the viewer 103, the viewer 103 receives the feature information from the server 104, recognizes the signboard or the sign part based on the received feature information, and displays the additional information of the store or the statue. With this configuration, the user can easily know the information of the building or the object.

As described above, even when there are a lot of wireless tags around the display apparatus, the viewer 103 can receive feature information and additional information corresponding to the upper limit number from the server 104, so that a processing load can be reduced. Further, a memory capacity in the viewer 103 can be effectively used.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention. In an example, a computer-readable storage medium may store a program that causes a display apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-105413 filed May 10, 2011, which is hereby incorporated by reference herein in its entirety.

What is claimed is:

1. A display apparatus configured to display a captured image, the display apparatus comprising:
an acquisition unit configured to acquire, from an external apparatus, additional information that is to be displayed in association with an object in the captured image;
a display unit configured to display the additional information acquired by the acquisition unit in association with the object; and
a setting unit configured to allow a user to set a set number of objects in association with which the additional information is to be displayed by the display unit,
wherein the acquisition unit is configured to acquire, from the external apparatus, the additional information according to the set number of objects.

2. The display apparatus according to claim 1, wherein the acquisition unit is configured to further acquire, from the external apparatus, feature information for detecting an object in the captured image, according to the set number of objects.

3. The display apparatus according to claim 1, further comprising a receiving unit configured to receive, from a communication apparatus, identification information of the communication apparatus,
wherein the acquisition unit is configured to acquire the feature information and the additional information associated with the identification information received by the receiving unit.

4. The display apparatus according to claim 3, further comprising a control unit configured to control the acquisition unit to acquire the feature information and the additional information according to the set number of objects by causing the receiving unit to receive identification information from communication apparatuses in a number corresponding to the set number of objects.

5. The display apparatus according to claim 3, wherein the receiving unit is configured to receive, from each of a plurality of communication apparatuses, identification information of each of the plurality of communication apparatuses, wherein the display apparatus further comprises:
a selection unit configured to select identification information of communication apparatuses in a number corresponding to the set number of objects, from among the identification information received by the receiving unit,
wherein the acquisition unit further is configured to acquire the feature information and the additional information associated with the identification information selected by the selection unit.

6. The display apparatus according to claim 5, wherein the selection unit is configured to select the identification information based on a radio signal strength indication from each of the plurality of communication apparatuses.

7. The display apparatus according to claim 1, wherein the acquisition unit is configured to automatically acquire a part of the additional information and then to acquire a rest of the additional information according to an instruction by a user.

8. The display apparatus according to claim 1, further comprising a detection unit configured to detect the object in the captured image by image recognition based on the feature information,
wherein the display unit is configured to display the additional information in association with the object detected by the detection unit.

9. A method for controlling a display apparatus, the method comprising:
acquiring, from an external apparatus, additional information that is to be displayed in association with an object in the captured image;
displaying the acquired additional information in association with the object; and
allowing a user to set a set number of objects in association with which the additional information is to be displayed,
wherein acquiring further includes acquiring, from the external apparatus, the additional information according to the set number of objects.

10. A non-transitory computer-readable storage medium storing a program that causes a display apparatus to perform the method according to claim 9.
